(19) United States
(12) Patent Application Publication
(10) Pub. No.: US 2006/0294220 A1
(43) Pub. Date: Dec. 28, 2006

(54) Diagnostics and resolution mining architecture

(75) Inventor: Eugene A. Asahara, Redwood City, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/157,837

(22) Filed: Jun. 22, 2005

(51) Int. Cl. G06F 15/173

(52) U.S. Cl. 709/224

(57) ABSTRACT

A system and method for automatically modifying a configurable system based on proposed changes calculated using a corresponding model network. The model network includes a plurality of nodes representing the elemental attributes of the configurable system as well as correlations between the nodes. Upon detection of one or more nodes having node values outside of a predetermined operating range, a proposed change for the configurable system is calculated and can be implemented with little or no intervention by users of the configurable system.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Advances in computing technology have allowed for the formation of increasingly large and/or complicated computer systems and networks. The speed of communication between various network elements also further blurs the line between what can be considered as a single computer and what is a network. Multiple processors, storage areas, input devices, and display devices can be connected to a single network and operated as a single computing machine.

The increasing complexity of networked computing devices has also led to difficulties in maintaining network performance at desired levels. Each increase in network complexity reduces the likelihood that an untrained user will be able to diagnose and/or resolve a problem occurring on a network. As a result, technical experts are increasingly in demand for troubleshooting networks and maintaining optimal performance.

Network diagnostic tools can be used to aid technical experts in identifying and resolving problems. In a model network, various properties of the real network can be modeled as nodes in the model network. Unfortunately, the model network still requires someone, such as a technical expert, to view any data or results produced by the model network and to implement any modeled changes into the real network.

### SUMMARY

In various embodiments, a system and method is provided for analyzing the performance of a configurable system, determining a change to the configurable system to improve performance, and implementing the proposed change. The configurable system can represent a computer network, a business organization, or other systems that can be represented by a model network of correlated nodes. The model network is used to identify changes to directly modifiable attributes of the configurable system that will lead to improved performance. In additional embodiments, a system and method is provided for updating the correlation values used in the model network.

### BRIEF DESCRIPTION OF THE DRAWINGS

FIG. 1 is a block diagram illustrating an overview of a system in accordance with an embodiment of the invention;

FIG. 2 is block diagram illustrating a computerized environment in which embodiments of the invention may be implemented;

FIG. 3 is schematic representation of relationships between various elements of a configurable system according to an embodiment of the invention.

FIG. 4 is a schematic representation of a model network according to an embodiment of the invention.

FIG. 5 is a sample iterative calculation to for determining proposed changes to node values according to an embodiment of the invention.

FIG. 6 is a flow chart illustrating a method for modifying a configurable system according to an embodiment of the invention.

FIG. 7 is a flow chart illustrating a method for modifying a model network according to an embodiment of the invention.

### DETAILED DESCRIPTION

### I. Overview

What is needed is a system and method for determining and implementing changes for a real network based on node values in a model network and implementing the changes. The method should be compatible with various network problems, including but not limited to computer networks. The method should further allow for automatic updating of the model network based on performance data aggregated from one or more real networks. When data from multiple networks is aggregated, the method should accommodate data from networks having different node connectivities.

More generally, what is needed is a system and method for determining and implementing changes to a system or object with a complex organizational or network structure. The system and method should provide a model to capture the interactions between various parts of the complex organization or network. The model can then be used to identify changes that will lead to improved performance for the system or object.

This invention provides a system and method for changing the configuration of a network to improve performance in the form of a Diagnostics and Resolution Mining Architecture (DRMA). When the performance of a configurable system is outside of a desired operating range, the invention provides a method for generating a change in the network configuration to remove or lessen the impairment. In an embodiment, the change can be implemented automatically, without any intervention from a user such as a technical expert. Because no user intervention is required, the amount of time needed to resolve a network performance issue can be minimized. Alternatively, the required change can be determined automatically and then implemented after notifying a designated user.

In another embodiment, the invention provides a system and method for determining a change to a network or organization. Based on a model showing relationships between various parts of the network or organization, a change leading to improved performance for the network or organization is determined. This change can then be automatically implemented, or recommended to an appropriate person (such as a user, manager, etc.) for implementation.

The invention also provides a method for modifying a node-based network model. This is accomplished by accumulating data on measured network performance data for one or more networks. The accumulated data is analyzed to determine the appropriate correlation factor between nodes that are correlated in the model. Thus, once the initial types of network correlations are defined, the correlation factors can be optimized so that the model reflects the actual network behavior as accurately as possible. In an embodiment, changes to one or more correlation factors in the model can be implemented without intervention by a technical expert. Alternatively, potential changes can be determined and then implemented after notifying a designated user.

In an embodiment involving a configurable system, such as a SQL network or other computer network, the invention is implemented using a model network having one or more nodes. The nodes of the model network represent the physical and behavioral characteristics of the configurable system, such as the CPU utilization of the network or the amount of memory allocated to each process running on the network. Some nodes are indicators of performance while other nodes represent changeable features of the corresponding configurable system. Each node in the model network is correlated with one or more other nodes to form correlated node pairs. These correlations represent the direct relationships between various nodes in terms of how a change in the value of one node results in a change, or trade-off, in the value of another node. A correlation value is assigned to each correlated node pair to indicate the type and magnitude of the correlation. Nodes which indicate the performance of the network can be assigned one or more upper or lower threshold values. When a node exceeds an upper threshold value (or falls below a lower threshold value), it indicates that the network is no longer performing in a desired manner. When a node exceeds (or falls below) a threshold value, a proposed change to one or more of the changeable features of the system is determined using the model network. If a proposed change can be found that returns all nodes of the network to within their desired operating ranges, the change is implemented to the configurable system.

In another embodiment, the invention can be implemented for an organization, such as a large business. In such an embodiment, the model network can have nodes corresponding to the physical and behavioral characteristics of the organization. The nodes can correspond to both performance indicators for the organization as well as characteristics of the organization that can be directly modified. For example, various nodes could represent stored raw materials, inventory of finished goods, or the number of workers assigned to a business function. Based on the relationships between nodes in the model, changes leading to improved performance can be identified and then either proposed to an appropriate party (such as a manager), or possibly implemented automatically.

### II. General Operating Environment

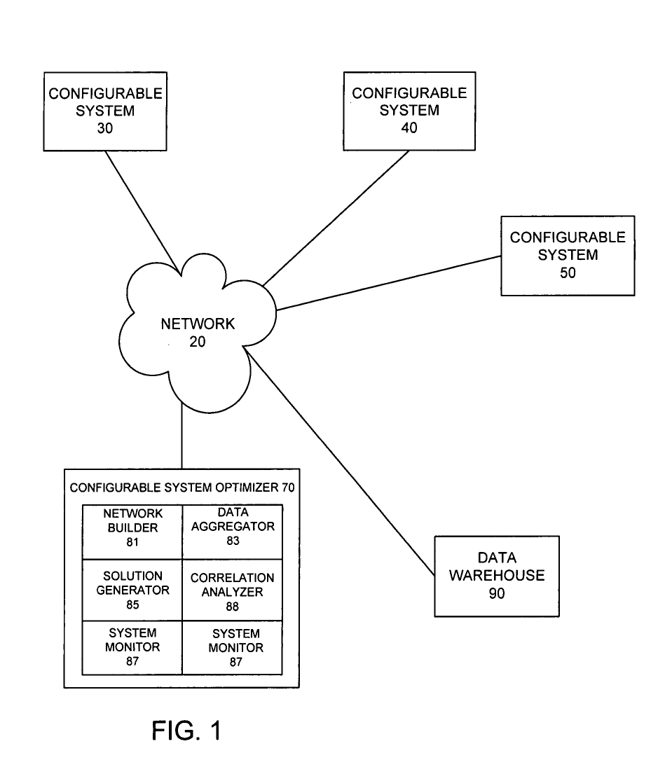

FIG. 1 illustrates a system for using a model network to propose and/or automatically implement changes to a configurable system according to an embodiment of the invention. One or more configurable systems, such as configurable systems 30, 40, and 50, can be connected via a network 20 to a system optimizer 70. Network 20 can represent a local area network, a wide area network, or any other type of network suitable for allowing a configurable system to communicate with system optimizer 70.

The configurable system optimizer 70 can include a model network builder 81 for constructing a model network of nodes and configuration switches to represent a configurable system 30, 40, or 50. The configurable system optimizer 70 can also include a data aggregator 83 for gathering node value data for nodes in a model network based on a corresponding configurable system. Data collected by data aggregator 83 can be stored locally or stored in a data warehouse 90. The configurable system optimizer 70 can further include a solution generator 85 for calculating proposed changes to configuration switches based on a model network corresponding to a configurable system 30, 40, or 50. The configurable system optimizer 70 can also include one or more system monitors 87 for tracking node values in a configurable system and detecting when a configurable system is operating outside of a desired range. Additionally, a correlation analyzer 88 can be included to analyze aggregated node value data and to provide revised correlation node values for use in a model network. Note that the components of configurable system optimizer 70 are shown as being part of a single system for convenience. In another embodiment one or more of the components of configurable system optimizer 70 could be located at one or more different locations and connected via network 20.

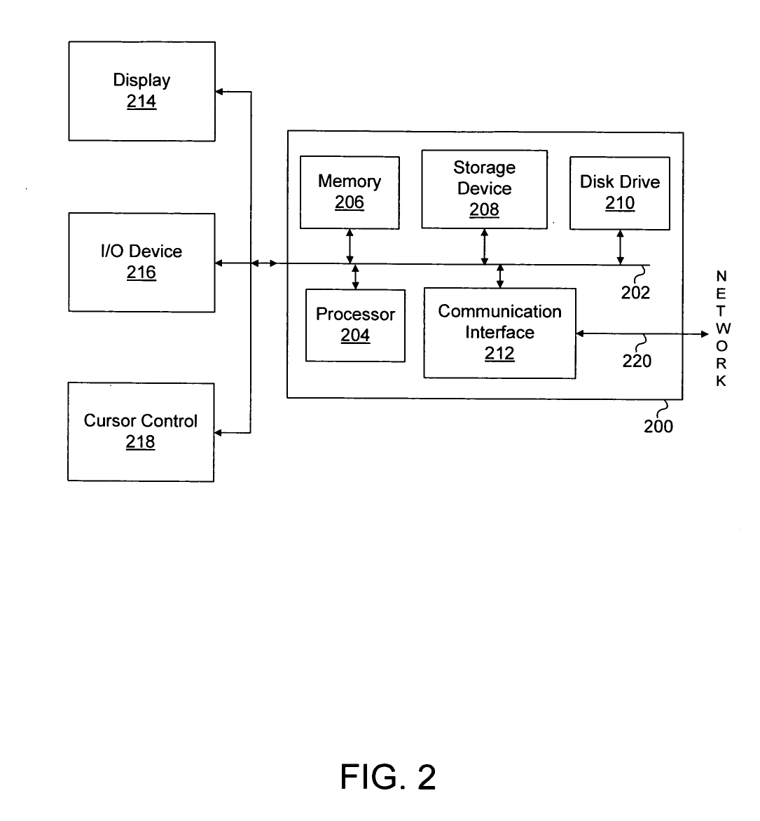

FIG. 2 illustrates an example of a suitable computing system environment 200 for implementing geographic based searching according to the invention. The computing system environment 100 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

FIG. 2 is a block diagram illustrating an exemplary computer system suitable for implementing a trade-off/semantic network. In some examples, computer system 200 may be used to implement the above-described techniques. Computer system 200 includes a bus 202 or other communication mechanism for communicating information, which interconnects subsystems and devices, such as processor 204, system memory 206 (e.g., RAM), storage device 208 (e.g., ROM), disk drive 210 (e.g., magnetic or optical), communication interface 212 (e.g., modem or Ethernet card), display 214 (e.g., CRT or LCD), input device 216 (e.g., keyboard), and cursor control 218 (e.g., mouse or trackball).

According to one embodiment of the invention, computer system 200 performs specific operations by processor 204 executing one or more sequences of one or more instructions contained in system memory 206. Such instructions may be read into system memory 206 from another computer readable medium, such as static storage device 208 or disk drive 210. In alternative embodiments, hard-wired circuitry may be used in place of or in combination with software instructions to implement the invention.

The term “computer readable medium” refers to any medium that participates in providing instructions to processor 204 for execution. Such a medium may take many forms, including but not limited to, non-volatile media, volatile media, and transmission media. Non-volatile media includes, for example, optical or magnetic disks, such as disk drive 210. Volatile media includes dynamic memory, such as system memory 206. Transmission media includes coaxial cables, copper wire, and fiber optics, including wires that comprise bus 202. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In an embodiment of the invention, execution of the sequences of instructions to practice the invention is performed by a single computer system 200. According to other embodiments of the invention, two or more computer systems 200 coupled by communication link 220 (e.g., LAN, PSTN, or wireless network) may perform the sequence of instructions to practice the invention in coordination with one another. Computer system 200 may transmit and receive messages, data, and instructions, including program, i.e., application code, through communication link 220 and communication interface 212. Received program code may be executed by processor 204 as it is received, and/or stored in disk drive 210, or other non-volatile storage for later execution.

### III. Network Nodes and Node Correlations

In an embodiment, a precursor to performing the method of this invention is providing a model that represents a configurable system. The model represents the configurable system or network as a plurality of nodes. The nodes can represent any desired behavior, characteristic, or risk associated with the network.

Each node in the model network is also correlated with one or more other nodes. These correlations, or trade-offs, describe the behavior of the network nodes when a node value is modified. The correlation between a pair of nodes is preferably a direct correlation or an inverse correlation, but other arbitrary algebraic functions can also be used. In an embodiment, the nodes in a model network are defined so that either one or zero trade-off relationships exist between any pair of nodes. Nodes that have at most one trade-off relationship with each other nodes can be referred to as “elemental” nodes.

One type of node used to represent the configurable system is an indicator node. An indicator node represents a measurable performance characteristic of the configurable system. As an example, an SQL network or other computer network can be the configurable system represented by the model network. A single physical component of the configurable system, such as the central processing unit, can correspond to multiple indicator nodes in the model network, such as CPU speed, CPU cache size, and CPU utilization. Other examples of indicator nodes can include the number of users on the system, the memory paging rate (use of disk space as temporary memory), or a data transfer rate through a particular device, router, or gateway in a network. Each node can have an arbitrary range of node values, such as binary values (representing ON/OFF or 0/1), a range from 0.0 to 100.0, a range including negative values, or any other convenient range of values for representing a node value. In an alternative embodiment, some or all node values in a system can be normalized to have a value between 0 and 100.

A second type of node in the configurable system is a configuration switch. A configuration switch represents an aspect of the configurable system that can be directly modified. In an example where the configurable system is a computer network, configuration switches can include operating system settings, such as the amount of disk space available for paging, the minimum memory size allocated to each process spawned in the system, or the maximum number of processes that can run concurrently on a CPU. Configuration switches can also include system flags that either enable or disable some feature or behavior in the system. Note that a node can serve as both a configuration switch and an indicator node.

In another embodiment, the configurable system can also include one or more risk nodes. A risk node is a node that indicates whether the configurable system is operating in a stable or “safe” manner. If one or more node values of the configurable system are modified so that the system is in an unusual or unstable operation state, one or more risk nodes would indicate the unusual state. These modifications to the node values can represent changes in the system behavior due to system operation, or the node value changes can be due to a proposed change in one or more configuration switches. Alternatively, rather than having explicit risk nodes in the model system, risks can be calculated along with a proposed change to one or more configuration switches. The risk value of a proposed change is then indicated along with the proposed change. Proposed changes with lower risk values are generally preferred relative to changes with high risk values.

Each of the indicator nodes in a representation of a configurable system can have one or more threshold values associated with the node. A threshold value for a node represents a node value indicating poor or unusual performance for the configurable system. For node values above the threshold value associated with an indicator node, the configurable system would be considered to have poor performance. A threshold value can represent a minimum value that the node value should stay above or a maximum value that the node value should stay below. A node can have multiple threshold values, to accommodate having either both a minimum and a maximum, or possibly to specify multiple discrete ranges of acceptable node values for a single node. For example, consider a node having normalized values between 0 and 100. The possible values for such a node can be broken down into several ranges. The middle range from 20-80 can represent a predetermined desired operating range for the node. For such a node, both 20 and 80 represent thresholds. For values below 20 the node is outside of the predetermined operating range because it is lower than a threshold value. Similarly, the node is outside of the predetermined operating range above 80 due to exceeding a threshold.

In the above description, nodes are described as either being within a desired operating range or being outside of the desired range. In another embodiment, additional designations can be used to describe node behavior, so that a node has multiple thresholds indicating different levels of problem. For example, for node values outside of the desired operating range, separate thresholds can be used to indicate a mild problem, an intermediate problem, or a severe problem. In still another embodiment, one or more node thresholds can be used to indicate a problem based on multiple nodes exceeding a threshold.

In a preferred embodiment, one or more indicator nodes have a plurality of thresholds, such as having at least a first upper threshold, a second upper threshold, and a third upper threshold. A predetermined node value range can be selected so that node values below the first upper threshold are within the desired operating range, or node values below the second upper threshold, or node values below the third upper threshold. In another embodiment, one or more indicator nodes can have a plurality of thresholds, such as having at least a first lower threshold, a second lower threshold, and a third lower threshold. A predetermined node value range can be selected so that node values above the first lower threshold are within the desired operating range, or node values above the second lower threshold, or node values above the third lower threshold.

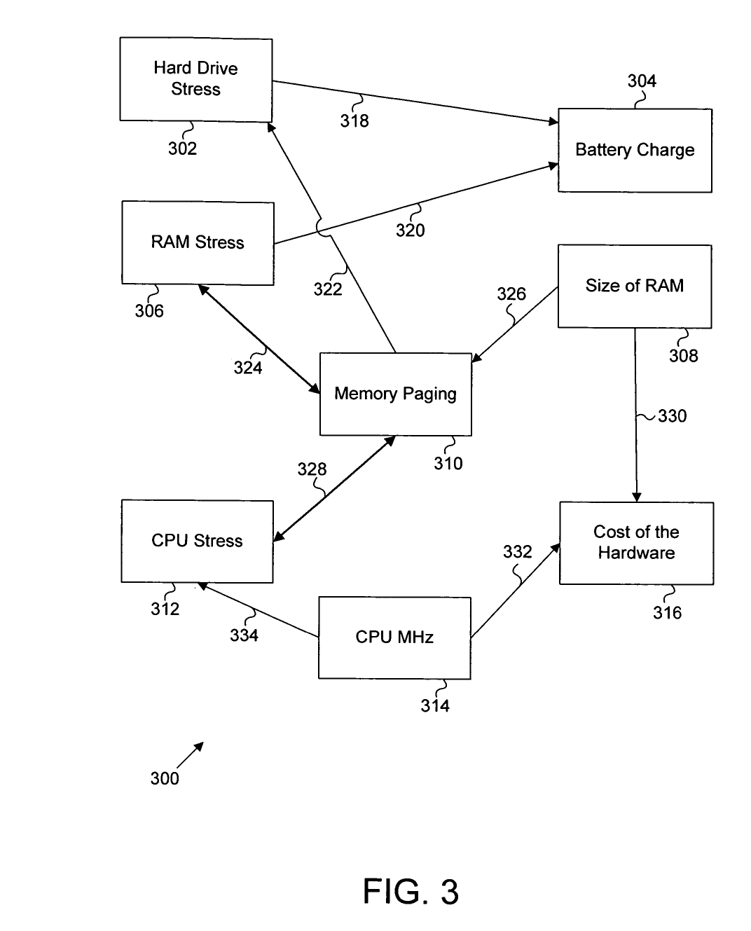

FIG. 3 illustrates an exemplary model network for representing a configurable system. In general, model network 300 is a mapping of trade-offs in a configurable system between various resources expressed as a collection of nodes. Model network 300 includes several examples of both indicator nodes and resource nodes. Elemental attributes include abstract representations of real-world system attributes such as performance characteristics, system or component parameters, environmental conditions, or the like. In other examples, elemental attributes may also be described as having a single value dimension. The configurable system represented by model network 300 is a fragment of an overall larger configurable system. In this example, a web-like or trade-off graph is shown, illustrating various elemental attributes associated with a computer system. Elemental attributes 302-316 represent basic aspects of a computer system such as hard drive stress, battery charge, random access memory (RAM) stress, size of RAM, memory paging, central processing unit (CPU) stress, CPU speed (expressed in megahertz, MHz), and cost of hardware. In other examples, configurable system 300 may be used to map other types of systems other than a computer system. Systems, devices, apparatus, logical structures, and other complex decision-making environments may be mapped, managed, and manipulated using configurable system 300.

Trade-off relationships 318-334 are shown between each of elemental attributes 302-316. These relationships illustrate basic characteristics of trade-offs between system resources or components when values for elemental attributes are adjusted. In some cases, modifying the value of a single elemental attribute may cause the value of an elemental attribute associated with a trade-off relationship to be affected in a directly proportional or inversely proportional manner. In the case of directly proportional relationships, the relationship between two elemental attributes is such that as the value of the first elemental attribute increases, the value of the second elemental attribute also increases. In the case of indirectly proportional relationships, the relationship between the two elemental attributes is such that as the value of the first elemental attribute increases, the value of the second elemental attribute decreases. In either case, the reverse may be true. In either case, the impact of modifying the value of one elemental attribute on another node may be referred to as an “affect.” Affects may also be described in terms of the direction or strength of a trade-off relationship. Trade-off relationships may also be described as unidirectional or bidirectional. In the case of unidirectional relationships, modifying the value of one elemental attribute has an affect on another elemental attribute, but not vice versa. For bidirectional relationships, two elemental attributes may affect each other across a trade-off relationship in either direction. In other words, a bidirectional relationship enables, for example, elemental attribute 306 to affect elemental attribute 310 and vice versa. By establishing a trade-off graph using elemental attributes connected through trade-off relationships, a system may be mapped to determine the particular effects changing one or more elemental attributes of a specific configuration.

### IV. Automated Improvements to the Performance of a Configurable System

In an embodiment, the node and correlation information contained in a model network can be used to automatically change the settings in a configurable system. This allows problems that develop in the configurable system to be remedied without waiting for intervention by a person such as a technical expert. Instead, once a problem is identified, a solution can be determined automatically and implemented in the configurable system. In an alternative embodiment, the invention can be used to determine and propose a change in the settings of a configurable system. A user of the system can then be notified of the proposed change before it is implemented.

In an embodiment, the configurable system is monitored to provide updated node values for the various indicator nodes in the model network. Node values can be updated periodically, continuously, or in any other convenient manner. When a node value falls outside of a desired range for a specified time period, such as by exceeding/falling below a threshold value, the configurable system is considered to be operating with lower performance. Alternatively, the node can be referred to as showing “pain” in the model network. A change to the system configuration is then determined so that all nodes in the model network are within the desired ranges (i.e., no node has any “pain.”)

In another embodiment, node values corresponding to the configurable system can be determined after receiving a notification from a user of the system, such as a complaint or another indication that the configurable system is performing poorly.

To determine an appropriate change to the system configuration, information about the nature of the pain is collected. The collected node values can be extracted from any convenient source, such as one or more logs dedicated to recording the values of a single node, one or more general system logs that include a desired node value, one or more dedicated logs for storing node values during times when poor system performance is detected, or a combination of any of the above. In an embodiment, recent information for all nodes in the system can be collected. In another embodiment, information is collected regarding only a subset of nodes. In such an embodiment, one or more recent node values for each node that is outside of normal operation is collected. The node values for one or more nodes that are logically close to the node having “pain” can also be collected.

In still another embodiment, node values are selected for collection based on a description provided in a complaint message provided by a system user. In such an embodiment, the complaint message is analyzed to determine a general problem type. For example, the complaint message can include a predetermined series of flags or check boxes that a message sender can use to describe a problem. Alternatively, the complaint message can be scanned for keywords indicating a general problem type. Based on the general problem type, a database or list is consulted to determine the node values that have been previously useful in resolving the general problem type. Recent values for these nodes are then collected.

The identity of the collected nodes, as well as the node values, can then be compared to the node values associated with previous system configuration changes. The node values from one or more previous system configuration changes can be stored in a database. If the current pattern of node values matches the pattern of a previous system pain stored in the database, the previous solution can be selected to attempt to resolve the pain.

If a previous solution cannot be found in the database, a configuration change is determined that resolves the pain. In an embodiment, a configuration change is determined using an iterative process. For example, a configuration change resolving the pain can be found using a genetic algorithm. In a genetic algorithm, the current state of the nodes in the model network is used as an initial guess. This initial guess serves as the first “parent” in the genetic algorithm. Two or more “child” solutions are then generated based on the parent by randomly varying the value of one or more resource nodes in the network. The child solution which is closer to providing a resolution is kept, and then more child solutions are proposed. This process is repeated until either a solution is found.

In another embodiment, a more refined version of a genetic algorithm can be used. In such an embodiment, the initial guess or initial “parent” for the genetic algorithm is formed using only a few nodes in the network. Preferably, the nodes will include each node exhibiting pain and any nodes that are part of a correlated pair with a node in pain. Nodes that are part of a correlated pair represent the logical “nearest neighbors” of the nodes in pain in the model network. The initial guess is formed by using the current values for the nodes in pain and any nearest neighbor nodes that are configuration switches. Two or more child generations are then developed by randomly varying some or all of the configuration switches in the initial guess. These changes to the configuration switches cause corresponding changes in the indicator nodes based on the correlations from the full network model.

For each generation, the genetic children are evaluated to determine the child that is closest to resolving the pain. If one of the genetic children appears to be closer to a desirable solution, that child is selected as the parent for the next generation. Alternatively, if none of the children appear to be closer to a desirable solution, the genetic children can be discarded and a new set of genetic children can be generated using the current parent.

In an embodiment, several factors can be considered to determine the child configuration that will be used to spawn the next generation. First, the indicator node values for the parent and all children are compared to determine how many nodes are outside the desired operating range as well as the level of pain for such nodes. Based on the comparison, one selection criteria can be whether a child has fewer nodes in severe pain as compared to the other children and the parent configuration. If two or more configurations have the same number of nodes in severe pain, the nodes can be compared to determine the node with the value closest to the severe pain threshold, as this configuration is closest to eliminating the severe pain condition. If two or more configurations have no nodes in severe pain, the configuration with lowest number of nodes in intermediate pain can be selected, or the lowest number of nodes having pain of any type.

Based on the selection criteria, either a child configuration can be selected to spawn the next generation, or the parent generation can be retained and used to randomly spawn a new set of children. Note that the above selection criteria, as well as other criteria, can be ordered in any desired manner for selecting the parent for each successive generation. As an example of another criteria, each child can be evaluated for risk, such as by evaluating any risk nodes within the network. If the risk value for a child generation is above a threshold value, the child can be discarded even though it may otherwise have the lowest number of nodes outside of the desired operating range.

The above process is repeated until a solution is found or a time limit is exceeded. A solution can be defined in various ways. In an embodiment, a solution corresponds to finding a child generation where no nodes are outside of desired operating ranges. In another embodiment, a solution can correspond to a child generation with no nodes in severe or intermediate pain. In such an embodiment, a maximum number of nodes in mild or low pain can also be required for a solution. However, in some cases the genetic algorithm may not produce a satisfactory solution within a fixed number of iterations or a fixed period of time. If a solution is not found, the genetic algorithm can be restarted with a new initial parent containing more configuration switches (nodes that can be directly manipulated) from the network. For example, the algorithm can be restarted using nodes in pain, nearest neighbor nodes that are configuration switches, and any next-nearest neighbor nodes that are configuration switches. This process can be repeated until either a solution is found or until the algorithm fails to find a solution even though all nodes from the model network are included in the genetic algorithm.

After a solution is found, the solution can be implemented on the corresponding configurable system. To implement the change, the elements in the configurable system corresponding to each configuration switch are modified based on the proposed changes.

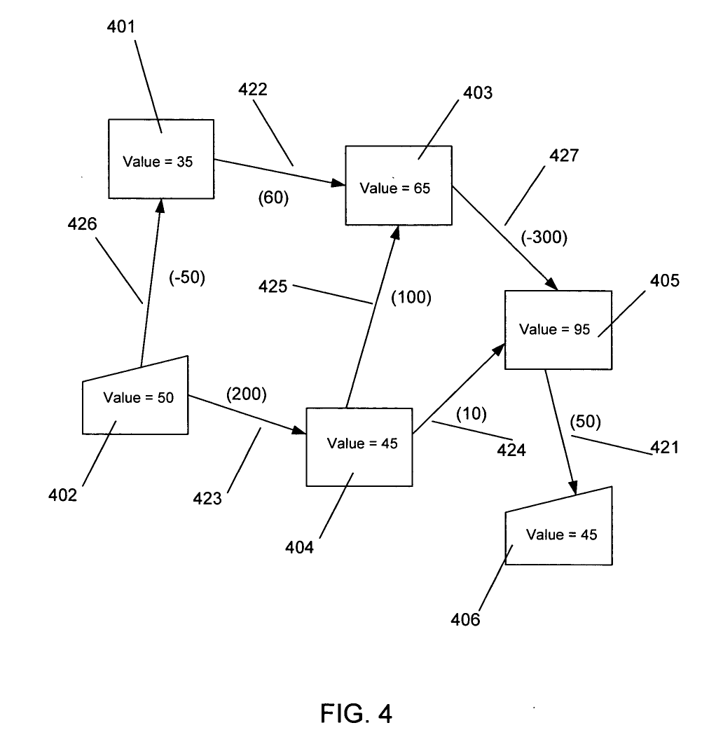

FIG. 4 shows a portion of a sample network 400 having a node operating outside of a desired range. In FIG. 4, a sample network containing 6 nodes is depicted. Nodes 402 and 406 of the sample network represent configuration switches that can be directly manipulated, while nodes 401, 403, 404 and 405 represent indicator nodes. Each of the nodes in this sample network has a value of between 0 and 100. This value is shown adjacent to each node in FIG. 4.

Each node in FIG. 4 is also correlated with one or more other nodes. Each correlation is indicated by an arrow, such as correlation 421 between node 406 and node 405. A number is listed in parentheses next to each correlation. This number indicates the correlation value between two nodes as a percentage. For example, correlation 425 between nodes 403 and 404 has a correlation value of 100. This means that any change in value for node 403 results in the same change in node 404. Similarly, based on the correlation value for correlation 421, a change in the value of node 406 results in a change that is 50% as large in node 405. Correlation values 422, 423, and 424 also show positive correlations, but with values ranging from 10% to 200%. Negative correlation values are also possible, as shown for correlations 426 and 427. Note that although all of the correlations shown in FIG. 4 are one way correlations, two way correlations are also possible.

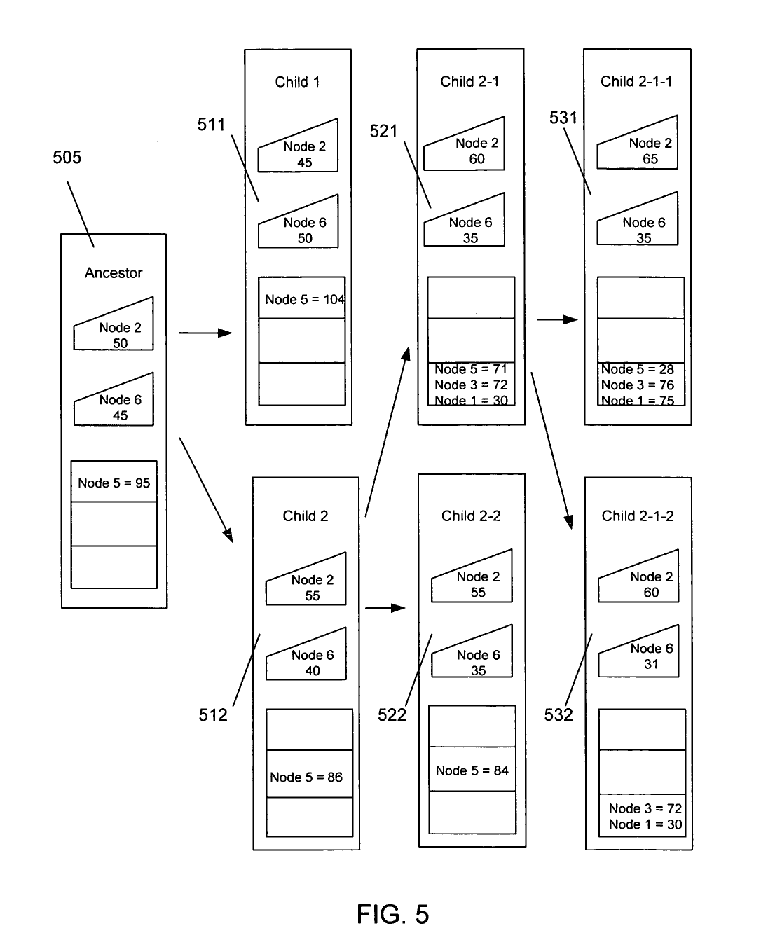

FIG. 5 shows an example of using a genetic algorithm to find a new configuration that causes all nodes to return to a desired range of operating values. The example in FIG. 5 is based on the model network depicted in FIG. 4. In this example, there are two threshold criteria for each indicator node. Each node has a first threshold value of 80, so that any node with a value above 80 is considered to be outside of the desired performance range. Second, if three or more nodes have either a node value above 70 or a node value below 30, the system is also considered to be outside of the desired operating range. Note that 30 and 70 represent additional threshold values for each of the nodes. In FIG. 4, node 405 has a node value of 95, which is above the first threshold value. In order to return the system to desired operation, the node value of node 405 needs to be reduced without causing another node to exceed its threshold value.

In FIG. 5, the genetic algorithm begins by selecting the two directly configurable nodes, configuration switches 402 and 406, for modification. The current values of nodes 402 and 406 are used as the initial generation, or parent 505. Two randomly determined variations are then calculated to form the second generation, children 511 and 512. Child 511 produces a higher node value for node 405, while child 512 produces a lower value. As a result, child 512 is selected for spawning the next generation, children 521 and 522. In child 522, node value 405 is still above 80. Child 521 has reduced node value 405 to below 71, but now node 403 is also above 70 while node 401 is below 30. Because no node is above its first threshold, child 521 is selected to spawn the next generation containing children 531 and 532. Node value 405 drops below 70 for child 532, causing this solution to satisfy all of the criteria for the desired system operating range. This solution can either be directly implemented in the corresponding configurable system, or a user of the configurable system can be alerted that this solution is ready and available for implementation.

### V. Aggregating Model Network Data

In another embodiment, the invention also provides for the aggregation of past performance data. The data can be aggregated for a single network, or for multiple model networks representing similar (but not necessarily identical) configurable systems. A similar but not identical configurable system represents a system of a similar general type that may have a different configuration. For example, various SQL server systems would be considered similar systems, even though differing model networks might be required to model the various SQL systems.

In an embodiment, data for an individual configurable system can be aggregated. In such an embodiment, node value data for the configurable system can be accumulated and stored. The data can be in the form of periodically accumulated data, or data collected by any other convenient method. The data can include both data from time periods when the configurable system is operating within desired ranges as well as data from time periods when the configurable system has “pain” associated with one or more nodes.

In another embodiment, data from one or more configurable systems can be aggregated by a central aggregation system. The aggregation system collects node value data for both time periods of operation within desired ranges as well as data from time periods where one or more nodes are outside of desired operating ranges. Data from configurable systems with similar but not identical configurations is handled by setting up categories for various types of nodes. For example, each time data from a new system will be added to the aggregated data, the correlated pairs of nodes from the model network can be categorized, so that the stored data is classified properly. Preferably, the data from each configurable system is converted to a standard format prior to aggregation.

### VI. Modifying Node Correlation Values

In still another embodiment, the node correlation values in a model network can be updated automatically based on an analysis of aggregated node value data. The aggregated node value data can be data corresponding to a single configurable system, or the aggregated data can be from multiple similar configurable systems.

Although the invention allows the correlation value between pairs of nodes to be updated, the update can only affect the coefficients of the value formula. For example, consider a pair of nodes that have a correlation relation where a change of Δx in a first node produces a change of y=a(Δx)²+b(Δx) change in the second node. The invention allows coefficients “a” and “b” to be updated, but not the basic quadratic nature of the correlation relation.

To update a correlation value between a pair of nodes, aggregated data for a configurable system is analyzed. The relationship between the values of the node pair is analyzed based on the form of the value formula used to define the node pair correlation. The analyzed data is used to determine the coefficients in the value formula. The coefficients can be determined using a conventional technique, such as least squares fitting.

### VI. Additional Examples

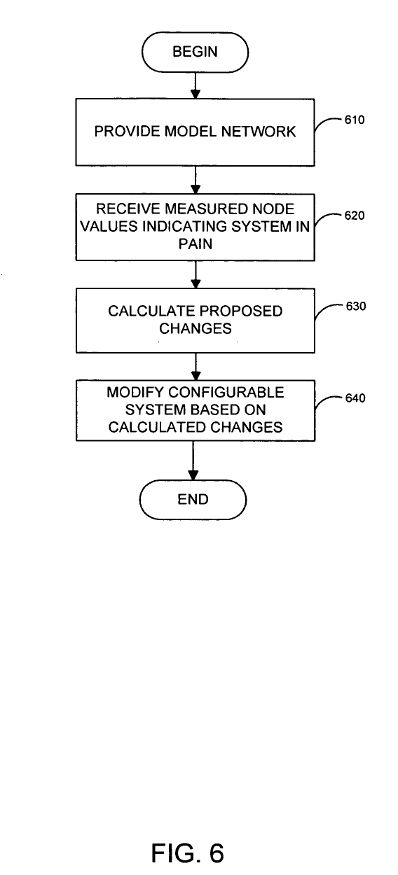

FIG. 6 depicts a flow chart of modifying a configurable system according to an embodiment of the invention. In FIG. 6, a model network corresponding to a configurable system is provided 610. The model network includes a plurality of indicator nodes, configuration switches, and optionally risk nodes, with each node being correlated to at least one other node. An indication is then received 620 that at least one indicator node or risk node in the model network has values outside of a predetermined operating range. This indicates that the configurable system is in “pain” and the performance of the system can be improved by modifying one or more elemental attributes of the system. Using the model network, a proposed change to one or more configuration switches is calculated 630. Elemental attributes of the configuration system are then modified 640 to correspond to the calculated changes in the one or more configuration switches.

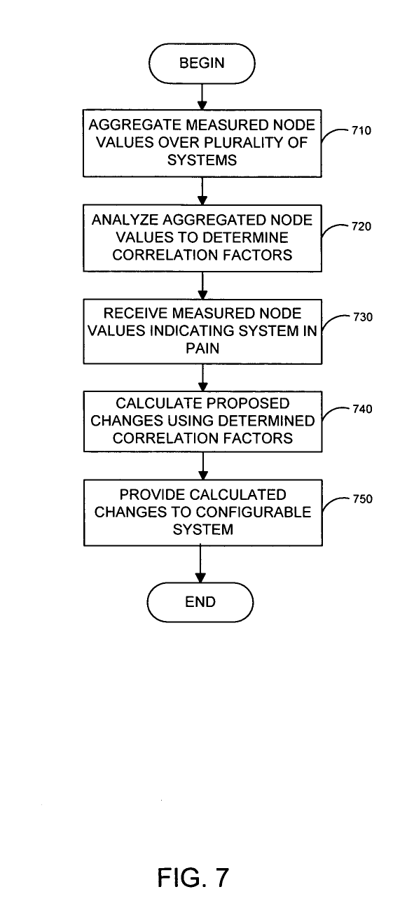

FIG. 7 depicts another flow chart showing a method of modifying the correlation values of a model network according to an embodiment of the invention. In FIG. 7, node values for a plurality of configurable system are aggregated 710. These aggregated node values are then analyzed 720 to determine relationships between various types of elemental attributes. For at least one of the model networks, revised correlation values are calculated for one or more node pairs. An indication is then received 730 that a model network with revised node correlation values has at least one indicator node or risk node with values outside of a predetermined operating range. Based on this indication, proposed changes to one or more configuration switches are calculated 740 using the revised node correlation values. These proposed changes are then provided 750 to the configurable system. The proposed changes can be implemented automatically by the configurable system, or a user of the configurable system can be notified prior to implementing the changes.

In addition to computer networks, such as SQL networks, the invention can also be implemented to improve the performance of other systems, networks, or organizations that are configurable systems. For example, in an embodiment the invention can be used to optimize the performance of a large business organization. In such an embodiment, a model can be constructed to model the trade-offs between various nodes and configuration switches for the organization (the configurable system). Examples of the indicator nodes in a model of the business organization can correspond to various measurable aspects of business performance, such as the amount of inventory, the amount of time inventory spends waiting in a warehouse, or the amount of time required to produce an item. Examples of configuration switches in a model for the business can correspond to things that can be directly changed, such as the number of people performing a given task or the amount and/or frequency with which raw materials are delivered to the beginning of a production line. The methods of the invention, such as the methods shown in FIGS. 6 and 7, can then be used to identify the proper correlation values between nodes in the business model and to propose changes to elemental attributes of the organization in order to resolve performance issues.

In another embodiment, the invention can be applied in a medical setting. In such an embodiment, a model can be constructed to model the trade-offs between various nodes and configuration switches for a patient (the configurable system), possibly based on data collected from other patients. Examples of indicator nodes for the patient model could include blood pressure, heart rate, the O₂ level in the patient's blood, or other measurable values for the patient. Examples of configuration switches for the patient model could include the number of hours of sleep, daily total calorie intake, or a medication such as a pill or an injected drug. The methods of the invention, such as the methods shown in FIGS. 6 and 7, can then be used to identify the proper correlation values between nodes in the patient model and to propose changes to elemental attributes in order to resolve health issues.

The following examples provide still other embodiments of the invention. In an embodiment, the invention provides a method for improving the performance of a configurable system. The method includes providing a network corresponding to a configurable system, the network having a plurality of indicator nodes and a plurality of configuration switches, each node having a measurable node value, wherein each node is correlated with at least one other node and has a correlation factor for each correlated node. The method also includes receiving measured node values for at least one indicator node, the measured node values being outside of a predetermined node value range. Node values are then calculated for one or more configuration switches using an iterative process, the calculated configuration switch values leading to a node value within the predetermined node value range for the at least one indicator node. Based on the calculated node values, one or more elemental attributes of the configurable system are then modified. In an alternative embodiment, the method described above can be implemented as instructions for a computer processor and stored on a computer readable medium.

In another embodiment, the invention provides a method for improving the performance of a configurable system. The method includes aggregating measured node values for networks corresponding to a plurality of configurable systems, each network having at least one indicator node, at least one configuration switch, and at least one node correlation between two or more nodes. The aggregated node values are analyzed to determine a correlation factor for one or more node correlations. The method also includes receiving measured node values for at least one indicator node from a network corresponding to one of the plurality of configurable systems, the measured node values being outside of a predetermined node value range. Node values are then calculated for one or more configuration switches from the network corresponding to one of the plurality of configurable systems using an iterative process, the calculated node values leading to a node value within the predetermined node value range for the at least one indicator node based on the correlation factors determined by analyzing the aggregated node values. The calculated nodes values for the one or more configuration switches can then be provided to the configurable system corresponding to the network. In an alternative embodiment, the method described above can be implemented as instructions for a computer processor and stored on a computer readable medium.

In still another embodiment, the invention provides a method for improving the performance of a configurable system. The method includes providing a network corresponding to a configurable system, the network having a plurality of indicator nodes and a plurality of resource nodes, each node having a measurable node value, wherein each node is correlated with at least one other node and has a correlation factor for each correlated node. The method also includes measuring node values corresponding to one or more indicator nodes and one or more resource nodes. The measured node values are sent to an aggregation service. One or more revised correlation factors are then received from the aggregation service, the revised correlation factors being based on the measured node values. The one or more correlation factors corresponding to the revised correlation factors received from the aggregation service are then modified.

Having now fully described this invention, it will be appreciated by those skilled in the art that the invention can be performed within a wide range of parameters within what is claimed, without departing from the spirit and scope of the invention.

What is claimed is:

1. A method for improving the performance of a configurable system comprising:
providing a model network corresponding to a configurable system, the model network having a plurality of indicator nodes and a plurality of configuration switches, each node having a measurable node value, wherein each node is correlated with at least one other node and has a correlation factor for each correlated node;
receiving measured node values for at least one indicator node, the measured node values being outside of a predetermined node value range;
calculating node values for one or more configuration switches using an iterative process, the calculated configuration switch values leading to a node value within the predetermined node value range for the at least one indicator node; and
modifying one or more elemental attributes of the configurable system based on the calculated node values.

2. The method of claim 1, wherein the model network further comprises one or more risk nodes.

3. The method of claim 1, wherein the received measured node values outside of the predetermined node value range comprise node values that are greater than a threshold value.

4. The method of claim 1, wherein the received measured node values outside of the predetermined node value range comprise node values that are less than a threshold value.

5. The method of claim 1, wherein one or more indicator nodes have a node value range comprising a first upper threshold, a second upper threshold, and a third upper threshold, the predetermined node value range comprising node values that are less than the second upper threshold.

6. The method of claim 1, wherein one or more indicator nodes have a node value range comprising a first lower threshold, a second lower threshold, and a third lower threshold, the predetermined node value range comprising node values that are greater than the second lower threshold.

7. The method of claim 1, wherein the configurable system corresponds to a network having one or more computers.

8. The method of claim 7, wherein modifying one or more elemental attributes of the configurable system comprises automatically modifying one or more elemental attributes based on the calculated node values.

9. The method of claim 1, wherein the configurable system corresponds to a business organization.

10. A method for improving the performance of a configurable system comprising:
aggregating measured node values for model networks corresponding to a plurality of configurable systems, each network having at least one indicator node, at least one configuration switch, and at least one node correlation between two or more nodes;
analyzing the aggregated node values to determine a correlation factor for one or more node correlations;
receiving measured node values for at least one indicator node from a model network corresponding to one of the plurality of configurable systems, the measured node values being outside of a predetermined node value range;
calculating node values for one or more configuration switches from the model network corresponding to one of the plurality of configurable systems using an iterative process, the calculated node values leading to a node value within the predetermined node value range for the at least one indicator node based on the correlation factors determined by analyzing the aggregated node values; and
providing the calculated node values for the one or more configuration switches to the configurable system corresponding to the network.

11. The method of claim 10, wherein calculating node values for one or more configuration switches using an iterative process comprises calculating node values using a genetic algorithm.

12. The method of claim 10, further comprising modifying one or more elemental attributes of the configurable system based on the calculated node values.

13. The method of claim 12, wherein the configurable system corresponds to a network having one or more computers.

14. The method of claim 13, wherein modifying one or more elemental attributes of the configurable system comprises automatically modifying the one or more elemental attributes.

15. A method for improving the performance of a configurable computer network comprising:
providing a model network corresponding to a computer network, the model network having a plurality of indicator nodes and a plurality of configuration switches, each node having a measurable node value, wherein each node is correlated with at least one other node and has a correlation factor for each correlated node;
receiving measured node values for at least one indicator node, the measured node values being outside of a predetermined node value range;
calculating node values for one or more configuration switches using an iterative process, the calculated configuration switch values leading to a node value within the predetermined node value range for the at least one indicator node; and
modifying one or more elemental attributes of the computer network based on the calculated node values.

16. The method of claim 15, wherein the received measured node values outside of the predetermined node value range comprise node values that are greater than a threshold value.

17. The method of claim 15, wherein the received measured node values outside of the predetermined node value range comprise node values that are less than a threshold value.

18. The method of claim 15, wherein one or more indicator nodes have a node value range comprising a first upper threshold, a second upper threshold, and a third upper threshold, the predetermined node value range comprising node values that are less than the second upper threshold.

19. The method of claim 15, wherein one or more indicator nodes have a node value range comprising a first lower threshold, a second lower threshold, and a third lower threshold, the predetermined node value range comprising node values that are greater than the second lower threshold.

20. The method of claim 15, wherein modifying one or more elemental attributes of the configurable system comprises automatically modifying one or more elemental attributes based on the calculated node values.
